(19) United States
(12) Patent Application Publication
(10) Pub. No.: US 2004/0057821 A1
(43) Pub. Date: Mar. 25, 2004

(54) Stone and boulder conveying apparatus

(76) Inventor: Kirk D. Samis, Aptos, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/254,894

(22) Filed: Sep. 25, 2002

(51) Int. Cl. B62B 1/00

(52) U.S. Cl. 414/490; 280/47.29

(57) ABSTRACT

A wheeled, hand-cart that has been configured to facilitate loading and carrying landscaping stones and boulders. A first embodiment is most suited to carrying stones and smaller boulders. A second embodiment is more suited to carrying larger boulders. The first embodiment is configured to have the maneuverability of a hand cart, but at least twice the capacity of a wheel barrow. It employs narrowed spaced handles located closer to the center of gravity of the rock-load cart to prevent injury to the hands while passing through gates and the like. A long V-shaped cage is configured with a deep angular receptacle with steep side walls to safely hold a large quantity of stones with minimal risk of fall through. The second employs a longer platform which provides a horizontal plane that is elevated several inches to be even with wheel axle height and to be pallet height to permit a boulder to be slid onto the platform.

### BACKGROUND OF THE INVENTION

1. Field of the Invention

The present invention relates generally to wheeled, hand-operated article carriers or carts and more specifically to a hand-cart apparatus which is especially advantageous for conveying boulders and large rocks such as those used in landscaping applications.

2. Background Art

There are a host of patents which relate to various apparatus for use in conveying articles. These devices are variously referred to as carts, dollies, hand trucks, carriers and the like. Generally, they tend to provide a platform for receiving articles, a support structure connecting the platform to at least one handle, and at least two wheels located in opposed relation to the platform on the lower portion of the support structure. The wheels support the platform and articles during transport and provide a fulcrum or pivot for rotating and elevating the platform around a common wheel axis to lift the articles. By way of example, U.S. Pat. No. 5,738,480 to Butzen discloses a two-wheeled dolly of the type commonly used for moving large heavy objects such as refrigerators and stackable storage boxes.

Unfortunately none of the prior art apparatus known to the applicant herein is suited to conveying boulders or significant quantities or large stones. Prior art apparatus do not adequately accommodate the high weight of stones such as those stones used in landscaping applications, particularly pond building, stone wall building and stone walkway construction. While such stones could be loaded into a standard wheel barrow, the height of the barrow dictates much more lifting than is desirable and the standard structure of such prior art apparatus is generally inadequate to hold and convey heavy boulders or a large quantity of stones. As used herein, the term “stones” refers to rocks having a mean diameter of at least six inches and the term “boulder” refers to rocks having a mean diameter of about fifteen inches to about forty inches. A typical stone weighs a minimum of about twenty pounds and a typical twenty inch boulder can easily weight at least two hundred pounds. In loading and conveying articles of such weight and girth, certain structural characteristics of the conveying apparatus can become critical and can determine whether the loading and conveying is a modest task or a monumental one. For example, if one can simply roll a stone or boulder into a cart at ground level or at pallet level, it is far easier and requires significantly less effort than if it were necessary to lift the rock or boulder a foot or two to load it into the cart. Sometimes the difference in that effort can be determinative of whether or not one man or woman alone can do the job. In another example, once a cart is loaded with say fifteen or twenty stones, simply pivoting the cart can become a very difficult task.

Based upon the foregoing, it can be seen that the conveying of landscaping stones and boulders presents very unique problems which can only be properly addressed by an apparatus especially designed for such a task. It is the applicant's belief that there are no prior art conveyors which are adequately designed to solve those unique problems.

### SUMMARY OF THE INVENTION

The present invention comprises a wheeled, hand-cart that has been uniquely configured to facilitate loading and carrying landscaping stones and boulders while overcoming many of the deficiencies of prior art carts used for that purpose. Two embodiments are disclosed herein. A first embodiment is most suited to carrying stones and smaller boulders. A second embodiment is more suited to carrying larger boulders. Unlike the prior art, both embodiments have a structure that is adequate to the task, in regard to both strength and capacity.

The first embodiment is configured to have the maneuverability of a hand cart, and at least twice the capacity of a wheel barrow. It employs narrowed spaced handles located closer to the center of gravity of the rock-load cart to prevent injury to the hands while passing through gates and the like. A long V-shaped cage is configured with a deep angular receptacle with steep side walls to safely hold a large quantity of stones with minimal risk of fall-through. The cage is preferably made with flat steel welded cross members. One end of the cage terminates in a platform preferably having a “home plate” shape which extends beyond the cage. A pair of opposed receptacles just outside the cage perimeter on the platform can receive a pair of fork members to increase the effective capacity of the platform. An extension having a T-shaped handle is slideably received at the bottom of the cage and may be extended beyond the handles to provide a selectable increased moment arm to facilitate rotation of a heavily burdened cage around two large wheels. An upper third wheel permits easy loading of the cage in a cart-like position. This wheel is mounted to provide a forward tilt or lean, keeping the rocks stable while being loaded.

The second embodiment is configured primarily for conveying a large boulder. It employs a longer platform which provides a horizontal plane that is elevated several inches to be even with wheel axle height and to be pallet height to permit a boulder to be slid onto the platform. The platform provides an open center pipe into which an elongated bar can be inserted to increase leverage to elevate the platform and boulder around the wheel axle. Two sets of double wheels increase weight capacity. A plurality of cross-members near the wheels spread the weight of the boulder across the entire structure. This embodiment also provides an upper additional wheel. Each of the embodiments is preferably configured to be sufficiently narrow to pass through opened gates (i.e., about 34 inches maximum).

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a first embodiment of the invention shown with its platform on the ground;

FIG. 2 is a view similar to that of FIG. 1, but shown with fork members installed in platform notches for receiving a large boulder;

FIG. 3 is a side view of the first embodiment shown in its barrow position for receiving a quantity of stones;

FIG. 4 is a three-dimensional view of a second embodiment of the invention shown with its platform on the ground; and

FIG. 5 is a view similar to that of FIG. 4, but shown with a boulder on the platform and with a leverage bar installed to facilitate elevation.

### DETAILED DESCRIPTION OF PREFERRED EMBODIMENTS

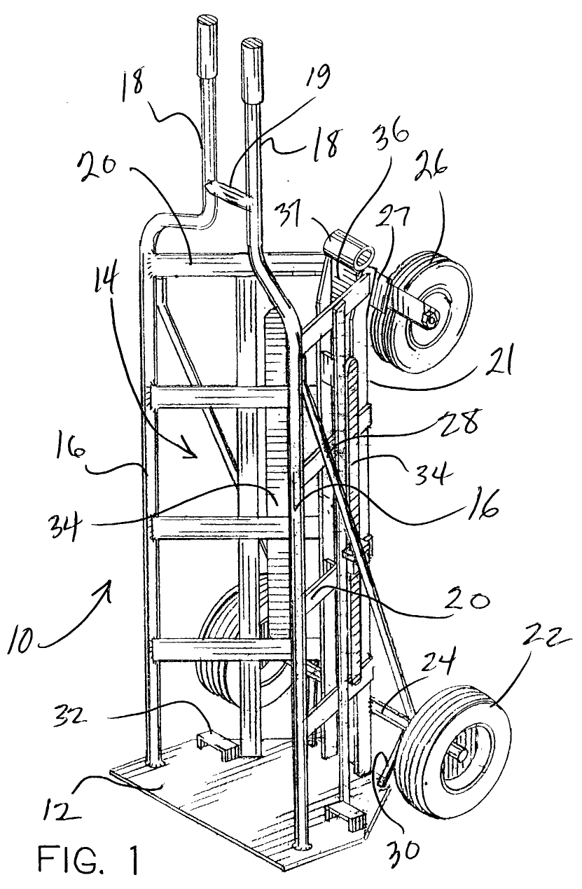

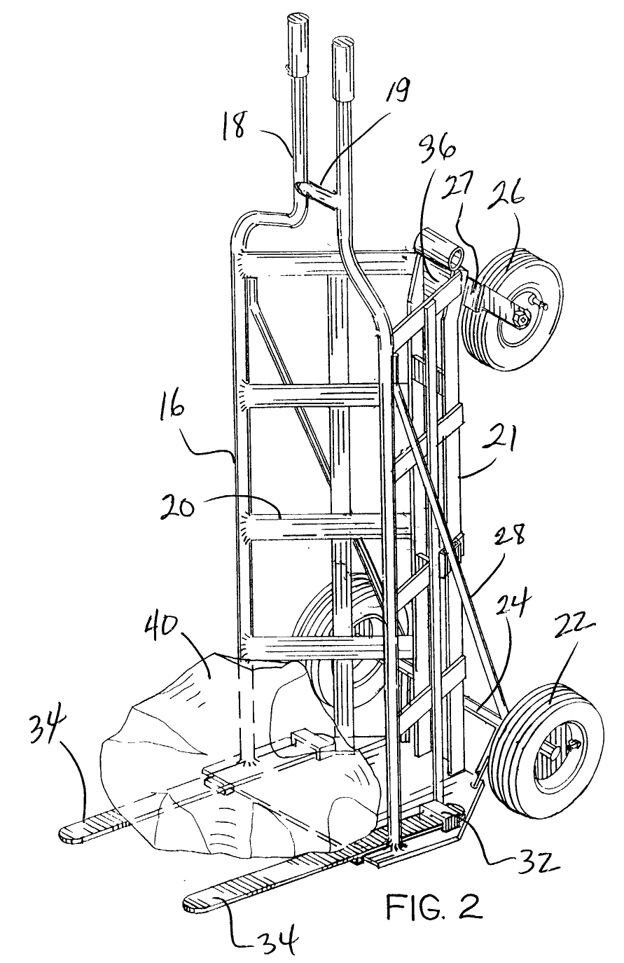

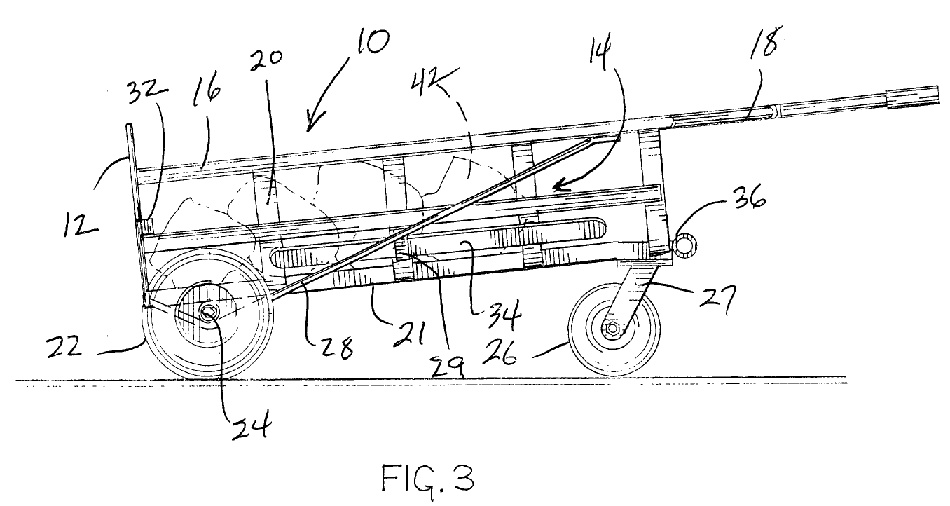

Referring to the accompanying figures and particularly FIGS. 1-3, it will be seen that a first embodiment 10 comprises a platform 12 and a rock cage 14. Cage 14 is of a generally angular V-shape and is formed by a plurality of long members 16 and cross members 20. The outer long members 16 are integral to a pair of handles 18 which are configured to be more closely spaced and to extend beyond cage 14 for easy access. Handles 18 are interconnected by a crossbar 19. Cage 14 bottoms out at a channel spine 21. A pair of large wheels 22 are rotatably mounted on a common axle 24 which is, in turn, connected to long members 16 by respective long struts 28 and to platform 12 by short struts 30. An upper wheel 26 is mounted by a wheel yoke 27 to the exterior surface of channel spine 21 as seen best in FIG. 3. A pair of fork members 34 are nominally stored as shown in FIG. 1 on the exterior of cage 14 in storage brackets 29 or may be deployed as shown in FIG. 2 in a pair of receptacles 32 on the margins of platform 12. The interior surface of channel spine 21 receives an extension 36 having a handle 37. Extension 36 may be slid out of channel spine 21 to provide a mechanically advantageous lever arm to rotate the cage around axle 24 to move a boulder 40 or stones 42 into the cage for conveying them to a different location.

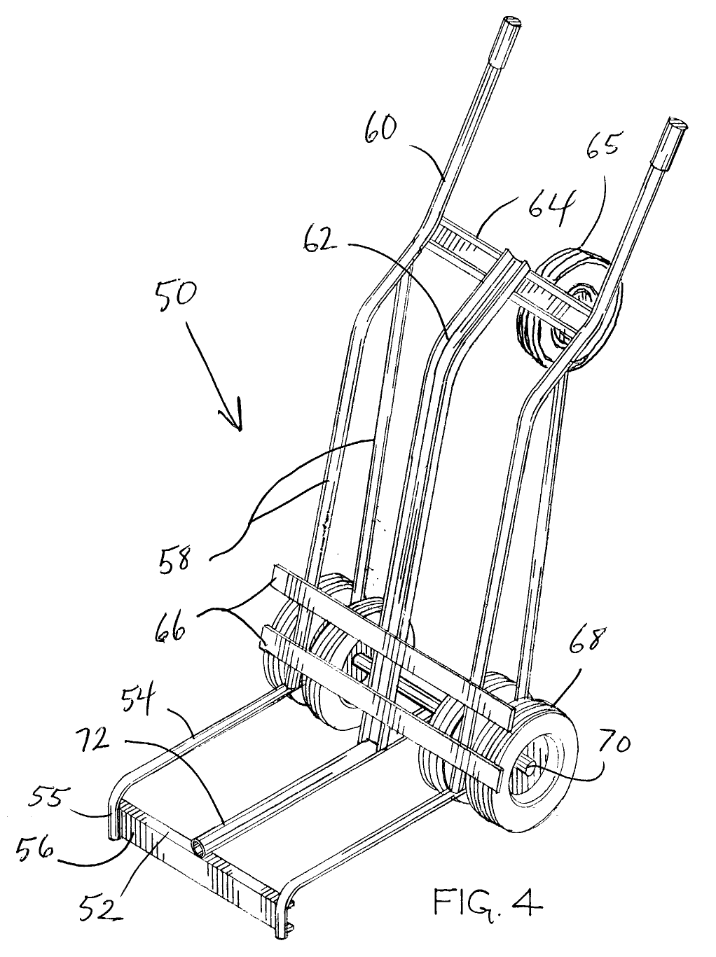

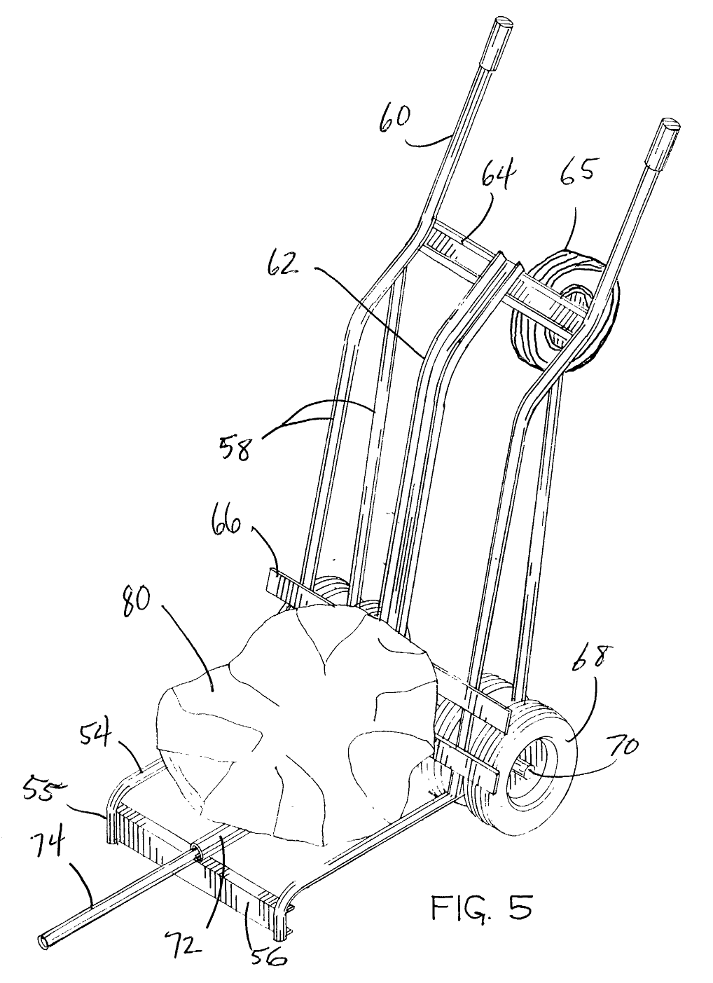

FIGS. 4 and 5 illustrate a second embodiment 50 used primarily for conveying large boulders such as boulder 80 of FIG. 5. A platform 52 comprises a pair of rails 54 connected to a horizontal beam 56 at their forward ends and to vertical members 58 at their other ends. Vertical members 58 on front and back of wheels 68 extend integrally into handles 60 and are interconnected by a horizontal reinforcing strut 64. A vertical reinforcing strut 62 extends from strut 64 to a pipe 72 which extends the length of platform 52. Pipe 72 receives a cylindrical lever bar 74 to assist in elevation of boulder 80 around wheels 68 and axle 70. A pair of boulder guard members 66 is affixed to each of the vertical members 58 on the platform side of wheels 68 to spread the load equally across the structure. It will be observed that the surface of platform 52 is elevated by virtue of the curved terminations 55 of rails 54. This elevation is designed to permit a boulder 80 to be slid from a pallet (not shown) directly onto the platform without a need to lift the boulder. An additional wheel 65 is positioned between handles 60 and attached to strut 64 to add versatility.

Based upon the foregoing, it will now be understood that the present invention provides a boulder and stone conveying apparatus having various unique features to facilitate loading and transport of such articles. While exemplary embodiments have been disclosed herein, the scope of the invention is limited only by the appended claims and their equivalents.

I claim:

1. A wheeled hand cart for transporting stones and boulders from a loading area to an unloading area; the cart comprising:
a platform configured for laying flat on a surface when said cart is vertically oriented for loading a large boulder into said cart;
a cage extending from said platform and having an angular interior cavity formed by a plurality of long members, a plurality of cross members and a central spine;
a pair of handles extending from said cage opposite said platform, said handles being spaced apart a distance less than the width of said cage; and
at least two wheels rotatably affixed to a common axle positioned behind said cage adjacent said platform.

2. The cart recited in claim 1 further comprising at least one fork member for extending said platform parallel to said surface and at least one receptacle on said platform for receiving said at least one fork member.

3. The cart recited in claim 1 further comprising an extension member slideably received in said central spine, said extension member extendable beyond said pair of handles for 'selectively providing an increased moment arm for rotating said cage around said axle.

4. The cart recited in claim 1 further comprising an additional wheel affixed to said spine at the handle end of said cage.

5. A wheeled hand cart for conveying heavy articles, the cart comprising:
an elongated V-shaped cage for receiving said articles;
at least two spaced wheels located at a first end of said cage;
an additional wheel located at a second end of said cage;
said additional wheel extending further from said cage than said at least two spaced wheels to tilt said cage toward said first end when said spaced wheels and said additional wheel are each in contact with an underlying surface.

6. The cart recited in claim 5 further comprising a platform enclosing said first end of said cage and configured for lying flat on said underlying surface when said cage is tilted around said spaced wheels into a vertical orientation.

7. The cart recited in claim 6 further comprising at least one fork member for selectively extending said platform beyond said cage.

8. The cart recited in claim 5 further comprising an extendable moment arm slideably received within said cage and selectively extendable therefrom for applying a rotating force to said cage around said spaced wheels.

9. The cart recited in claim 5 further comprising a pair of spaced apart handles extending from said cage at said second end, the spacing between said handles being less then the spacing between said spaced wheels.

10. A wheeled hand cart for conveying boulders and other heavy articles; the cart comprising:
a platform for receiving at least one of said boulders with the cart in a substantially vertical position and said platform extending horizontally;
a vertical section having a plurality of elongated members, said vertical section and said platform being interconnected along a fulcrum axis; and
a plurality of wheels mounted on an axle, said axle being substantially aligned with said axis;
said platform being elevated above the lowermost surface of said wheels for receiving said at least one of said boulders from a similarly elevated surface.

11. The cart recited in claim 10 wherein said platform comprises a moment arm extension receptacle.

12. The cart recited in claim 11 further comprising a moment arm extension for attachment to said receptacle for elevating said platform around said fulcrum axis.

13. The cart recited in claim 10 further comprising an additional wheel affixed to said vertical section between said vertical members.

14. The cart recited in claim 10 wherein at least one of said vertical members is extended to form an integral handle of said cart.
